(19) United States
(12) Patent Application Publication
(10) Pub. No.: US 2013/0094263 A1
(43) Pub. Date: Apr. 18, 2013

(54) POWER SUPPLY DEVICE

(71) Applicant: CHUN-AN LAI, Tu-Cheng (TW)

(72) Inventor: CHUN-AN LAI, Tu-Cheng (TW)

(73) Assignee: HON HAI PRECISION INDUSTRY CO., LTD., Tu-Cheng (TW)

(21) Appl. No.: 13/439,839

(22) Filed: Apr. 4, 2012

(30) Foreign Application Priority Data
Oct. 14, 2011 (TW) 100137410

(51) Int. Cl. H02M 7/217

(52) U.S. Cl. 363/127

(57) ABSTRACT

A power supply device includes an input connector, an alternating current (AC)/direct current (DC) converter, a plurality of voltage converters, and a plurality of output connectors corresponding to the voltage converters. The input connector is electrically connected to a power supply. The AC/DC converter converts an AC electric potential provided by the power supply to a DC electric potential, and the voltage converters convert the DC electric potential generated by the AC/DC converter to DC electric potentials having predetermined effective values and output the DC electric potentials from the output connectors, respectively.

### BACKGROUND

1. Technical Field

The present disclosure relates to power supply devices, and particularly to a power supply device capable of providing electric potentials having various voltage values.

2. Description of Related Art

Various electric appliances may require various electric potentials. A single potential is provided by many household power supplies, where different electric appliances may need voltage converters, which are configured for converting the potential provided by the household power supplies into various electric potentials adapted to be used by the different electric appliances. However, many voltage converters may be costly, and the individual electric connections for these voltage converters may be complicated.

Therefore, there is room for improvement within the art.

### BRIEF DESCRIPTION OF THE DRAWINGS

Many aspects of the present disclosure can be better understood with reference to the following drawings. The components in the various drawings are not necessarily drawn to scale, the emphasis instead being placed upon clearly illustrating the principles of the present disclosure. Moreover, in the drawings, like reference numerals designate corresponding parts throughout the figures.

FIG. 1 is a schematic view of a power supply device, according to an exemplary embodiment.

FIG. 2 is a block diagram of the power supply device shown in FIG. 1, where an alternating current (AC) power supply provides electric power to a plurality of electric appliances via the power supply device shown in FIG. 1.

FIG. 3 is a block diagram of a voltage converter of the power supply device shown in FIG. 2.

### DETAILED DESCRIPTION

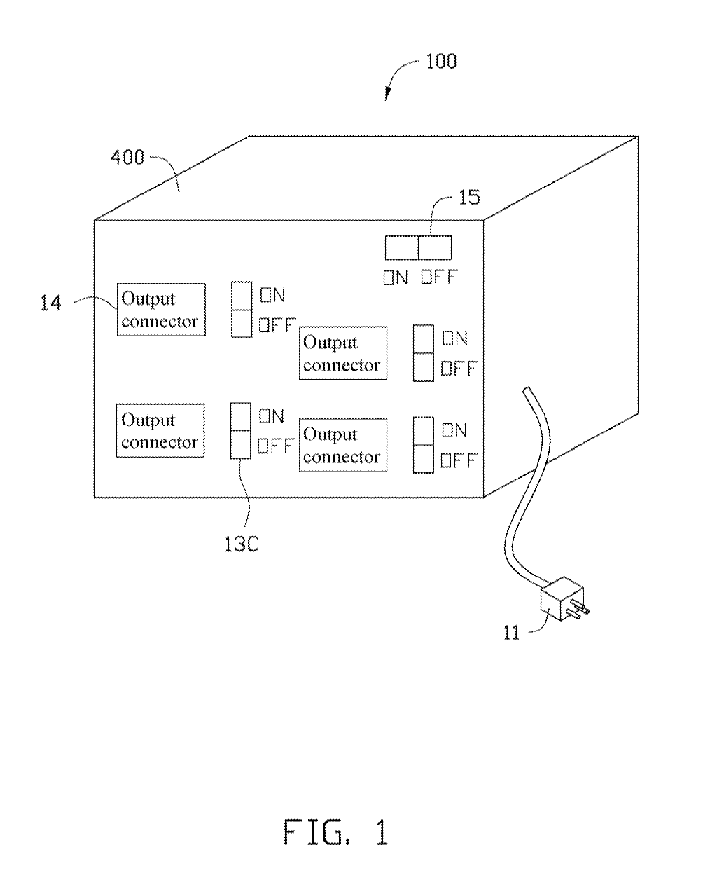

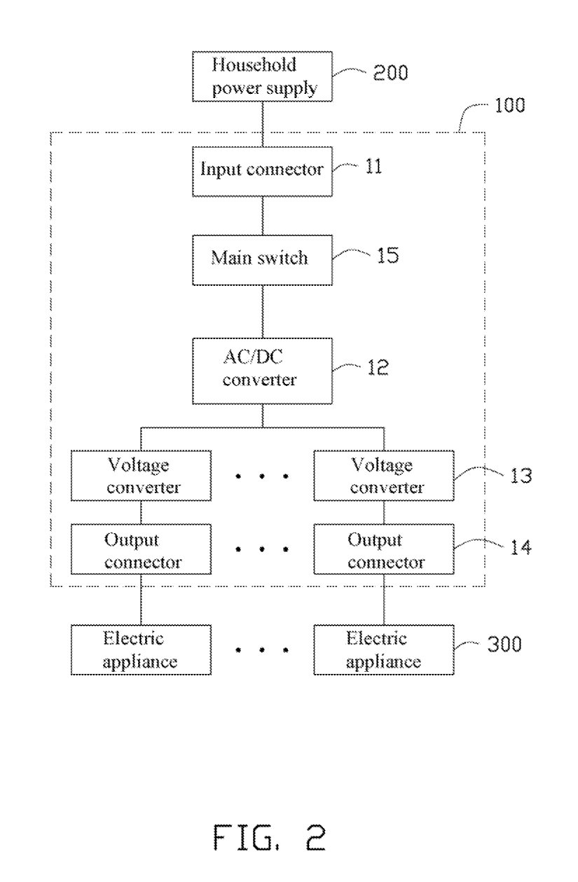

FIG. 1 shows a power supply device 100, according to an exemplary embodiment. Also referring to FIG. 2, a plurality of electric appliances 300 can be electrically connected to a universal household power supply 200 via the power supply device 100. The power supply device 100 can convert the electricity provided by the household power supply 200 into various electric potentials having voltage values adapted to be used by the electric appliances 300, and provide the converted electric potentials to the electric appliances 300.

The power supply device 100 includes a housing 400, an input connector 11, an alternating current (AC) to direct current (DC) converter (AC/DC converter 12), a plurality of voltage converters 13 corresponding to the requirements of the electric appliances 300, and a plurality of output connectors 14 corresponding to the voltage converters 13. The input connector 11 can be a plug configured for electrically connecting with the household power supply 200. The AC/DC converter 12 is electrically connected to the input connector 11. The voltage converters 13 are all electrically connected to the AC/DC converter 12, and each of the output connectors 14 are electrically connected to a voltage converter 13. Each of the electric appliances 300 can be electrically connected simultaneously to a correct output connector 14. Furthermore, the power supply device 100 can further include a main switch 15. The main switch 15 can be electrically connected between the input connector 11 and the AC/DC converter 12 to switch on and off the overall supply of electrical power.

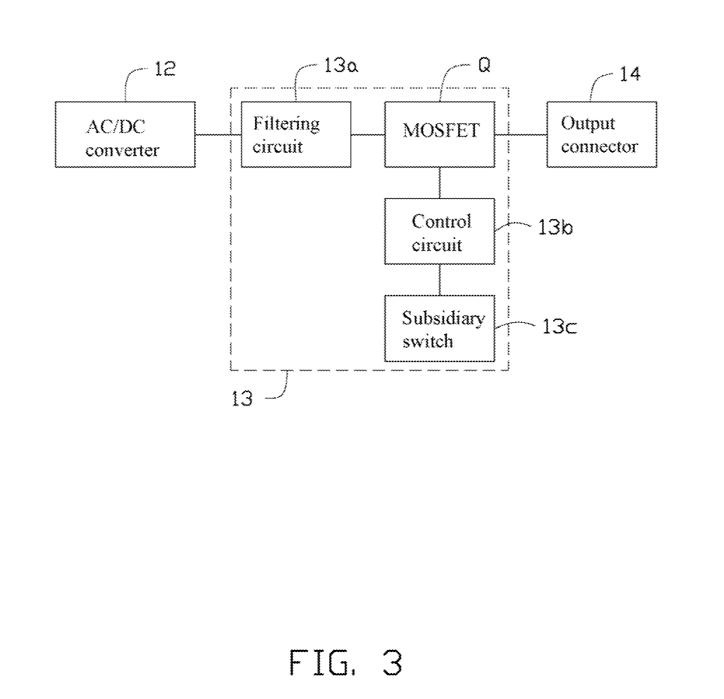

Also referring to FIG. 3, each of the voltage converters 13 includes a filtering circuit 13a, a metal-oxide-semiconductor field-effect transistor (MOSFET) Q, and a control circuit 13b. An input end (e.g., a drain) of the MOSFET Q is electrically connected to the AC/DC converter 12 via the filtering circuit 13a. An output end (e.g., a source) of the MOSFET Q is electrically connected to the output connector 14 corresponding to the voltage converter 13. A switch end (e.g., a gate) of the MOSFET Q is electrically connected to the control circuit 13b. The control circuit 13b can be a pulse width modulation (PWM) controller.

In use, the main switch 16 is turned on, and the AC/DC converter 12 is thereby electrically connected to the household power supply 200 via the main switch 16 and the input connector 11. Thus, the AC/DC converter 12 receives an AC supply from the household power supply 200 and converts the AC into a DC. The DC is transmitted to the input end of the filtering circuit 13a of each of the voltage converters 13.

In each of the voltage converters 13, the filtering circuit 13a of the voltage converter 13 filters the supply provided by the AC/DC converter 12 to remove any AC portions remaining in the DC electric potential, and transmits a filtered DC to the input end of the MOSFET Q of the voltage converter 13. The control circuit 13b generates a control signal and transmits the control signal to the switch end of the MOSFET Q to periodically turn the MOSFET Q on and off. When the MOSFET Q is turned on, the filtered DC is transmitted to the output connector 14 corresponding to the voltage converter 13 via the output end of the MOSFET Q. In this way, the voltage converter 13 generates a pulsating DC voltage, which is transmitted to the electric appliance 300 connected to the output connector 14.

In this embodiment, the control signal is a PWM signal. In each of the voltage converters 13, the control circuit 13b can adjust the turned-on time of the MOSFET Q by means of adjusting a duty cycle or ratio of the control signal, and thus adjust the effective value of the pulsating DC voltage provided to the electric appliance 300. In this way, each of the voltage converters 13 can output a DC pulsating voltage with a predetermined effective value. Therefore, the power supply device 100 can synchronously output a plurality of pulsating DC voltages with different effective values to supply the correct type of electrical power to different electric appliances 300.

As detailed above, the power supply device 100 can convert the AC provided by the household power supply 200 into a plurality of pulsating DC voltages of different predetermined effective values, and output the pulsating DC voltages to electric appliances 300. Thus, the single power supply device 100 can replace a multitude of various types of voltage converters configured for converting household power supplies into various electric potentials adapted for each of a multitude of electric appliances 300, thereby saving cost and avoiding a multitude of different electrical connection operations to the electric appliances 300.

Furthermore, each of the voltage converters 13 includes a subsidiary switch 13c electrically connected to the control circuit 13b and mounted on an outer surface of the housing 400. For any electric appliance 300 which is not being used, the control circuit 13b of the voltage converter 13 corresponding to the particular output connector 14 which is not needed can be turned off by operating the subsidiary switch 13c of the voltage converter 13. Thus, the voltage converter 13 avoids generating pulsating DC voltages which are wasted.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A power supply device, comprising:
an input connector configured for electrically connecting with a power supply;
an alternating current (AC)/direct current (DC) converter electrically connected to the input connector;
a plurality of voltage converters electrically connected to the AC/DC converter; and
a plurality of output connectors correspondingly electrically connected to the voltage converters;
wherein the AC/DC converter converts an AC electric potential provided by the power supply to a DC electric potential, and the voltage converters convert the DC electric potential generated by the AC/DC converter to DC electric potentials having predetermined effective values and output the DC electric potentials from the output connectors, respectively.

2. The power supply device as claimed in claim 1, wherein each of the voltage converters includes a metal-oxide-semiconductor field-effect transistor (MOSFET) and a control circuit; an input end of the MOSFET is electrically connected to the AC/DC converter, an output end of the MOSFET is electrically connected to the output connector corresponding to the voltage converter, and a switch end of the MOSFET is electrically connected to the control circuit.

3. The power supply device as claimed in claim 2, wherein the control circuit generates a control signal and transmits the control signal to the switch end of the MOSFET to periodically turn on and off the MOSFET, and the DC electric potential generated by the AC/DC converter is transmitted to the output connector corresponding to the voltage converter when the MOSFET is turned on, such that the voltage converter converts the DC electric potential generated by the AC/DC converter to a pulsating DC electric potential and outputs the pulsating electric potential from the output connector corresponding to the voltage converter.

4. The power supply device as claimed in claim 3, wherein the control signal is a pulse width modulation (PWM) signal, and the effective value of the pulsating electric potential is adjusted by adjusting a duty ratio of the control signal.

5. The power supply device as claimed in claim 3, wherein each of the voltage converters further includes a filtering circuit electrically connected between the AC/DC converter and the input end of the MOSFET of the voltage converter that removes remaining AC portions in the DC electric potential generated by the AC/DC converter.

6. The power supply device as claimed in claim 3, wherein each of the voltage converters further includes a switch electrically connected to the control circuit of the voltage converter for turning on and off the control circuit of the voltage converter.
